(19) United States
(12) Patent Application Publication
(10) Pub. No.: US 2026/0196192 A1
(43) Pub. Date: Jul. 9, 2026

(54) PLATE MATERIAL, MUSICAL INSTRUMENT, AND STRING INSTRUMENT

(71) Applicant: Yamaha Corporation, Shizuoka (JP)

(72) Inventor: Naoki KAWAGUCHI, Shizuoka (JP)

(21) Appl. No.: 19/550,868

(22) Filed: Feb. 26, 2026

Related U.S. Application Data
(63) Continuation of application No. PCT/JP2024/029502, filed on Aug. 20, 2024.

(30) Foreign Application Priority Data
Sep. 7, 2023 (JP) 2023-145432

(51) Int. Cl. G10D 3/22; G10D 1/08

(52) U.S. Cl. CPC G10D 3/22; G10D 1/08

(57) ABSTRACT

A plate material includes a first layer including a plurality of voids. The plurality of voids are arranged spaced apart from each other in a planar direction including a first direction and a second direction, the first direction is perpendicular to a plate thickness direction of the plate material, and the second direction is perpendicular to the plate thickness direction and to the first direction. A first shear modulus in a first plane including the plate thickness direction and the first direction is lower than a second shear modulus in a second plane including the plate thickness direction and the second direction and to the first direction.

### CROSS-REFERENCE TO RELATED APPLICATIONS

This application is a continuation application of PCT International Application No. PCT/JP2024/029502 filed on August 20, 2024, which claims priority to Japanese Patent Application No. 2023-145432 filed in Japan on September 7, 2023. The entire disclosures of International Application No. PCT/JP2024/029502 and Japanese Patent Application No. 2023-145432 are hereby incorporated herein by reference.

### BACKGROUND

### Field of the Invention

This disclosure generally relates to a plate material, a musical instrument, and a string instrument.

### Background Information

Musical instruments such as acoustic guitars and acoustic pianos include a plate material that generate sound by vibrating (for example, refer to US Patent No. 7342161).

### SUMMARY

Specific types of wood (for example, spruce) that generate a suitably soft sound may be preferably used in plate materials used in musical instruments, and the like. Soft sound is sound in which the magnitude of higher-order vibrations (high-frequency sounds) is suitably suppressed.

However, if the specific type of wood is expensive or difficult to obtain, it is difficult to obtain a plate material that generates a suitably soft sound. Therefore, there is a demand to obtain wood that generates a suitably soft sound without being limited to specific types of wood.

In consideration of the circumstances described above, an object of this disclosure is to provide a plate material that can generate a suitably soft sound even when the plate material is made of a material other than specific types of wood, as well as a musical instrument and a string instrument that include such a plate material.

One aspect of this disclosure is a plate material that comprises a first layer including a plurality of voids. The plurality of voids are arranged spaced apart from each other in a planar direction including a first direction and a second direction, the first direction is perpendicular to a plate thickness direction of the plate material, and the second direction is perpendicular to the plate thickness direction and to the first direction. A first shear modulus in a first plane including the plate thickness direction and the first direction is lower than a second shear modulus in a second plane including the plate thickness direction and the second direction and to the first direction.

A second aspect of this disclosure is a musical instrument comprising the plate material.

A third aspect of this disclosure is a string instrument comprising the plate material and strings, and the second direction of the plate material substantially coincides with the longitudinal direction of the strings.

### BRIEF DESCRIPTION OF THE DRAWINGS

FIG. 1 is a perspective view showing one example of a string instrument to which a plate material of this disclosure is applied.

FIG. 2 is a schematic diagram for explaining a first shear modulus and a second shear modulus in the plate material of this disclosure.

FIG. 3 is an exploded perspective view showing a main part of the plate material according to a first embodiment of this disclosure.

FIG. 4 is a plan view showing the main part of the plate material according to the first embodiment of this disclosure, with a portion of one second layer cut away.

FIG. 5 is a cross-sectional view taken along line V-V in FIG. 4.

FIG. 6 is a cross-sectional view showing a modified example of the plate material according to the first embodiment of this disclosure.

FIG. 7 is a plan view showing a main part of a first layer of a plate material according to a second embodiment of this disclosure.

FIG. 8 is a plan view showing a main part of a first layer of a plate material according to a third embodiment of this disclosure.

FIG. 9 is a plan view showing a main part of a first layer of a plate material according to a fourth embodiment of this disclosure.

FIG. 10 is an enlarged cross-sectional view of the plate material of FIG. 9 cut in a direction perpendicular to the Z-axis direction.

FIG. 11 is a perspective view showing a first example of one unit of a lattice structure constituting a plate material according to another embodiment of this disclosure.

FIG. 12 is a perspective view showing a second example of one unit of a lattice structure constituting a plate material according to another embodiment of this disclosure.

FIG. 13 is a perspective view showing a third example of one unit of a lattice structure constituting a plate material according to another embodiment of this disclosure.

FIG. 14 is a perspective view showing a fourth example of one unit of a lattice structure constituting a plate material according to another embodiment of this disclosure.

FIG. 15 is a perspective view showing a fifth example of one unit of a lattice structure constituting a plate material according to another embodiment of this disclosure.

FIG. 16 is a perspective view showing a sixth example of one unit of a lattice structure constituting a plate material according to another embodiment of this disclosure.

FIG. 17 is a perspective view showing a seventh example of one unit of a lattice structure constituting a plate material according to another embodiment of this disclosure.

FIG. 18 is a perspective view showing an eighth example of one unit of a lattice structure constituting a plate material according to another embodiment of this disclosure.

FIG. 19 is a perspective view showing a ninth example of one unit of a lattice structure constituting a plate material according to another embodiment of this disclosure.

FIG. 20 is a perspective view showing a tenth example of one unit of a lattice structure constituting a plate material according to another embodiment of this disclosure.

FIG. 21 is a perspective view showing an eleventh example of one unit of a lattice structure constituting a plate material according to another embodiment of this disclosure.

FIG. 22 is a perspective view showing a twelfth example of one unit of a lattice structure constituting a plate material according to another embodiment of this disclosure.

FIG. 23 is a perspective view showing a thirteenth example of one unit of a lattice structure constituting a plate material according to another embodiment of this disclosure.

### DETAILED DESCRIPTION OF EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

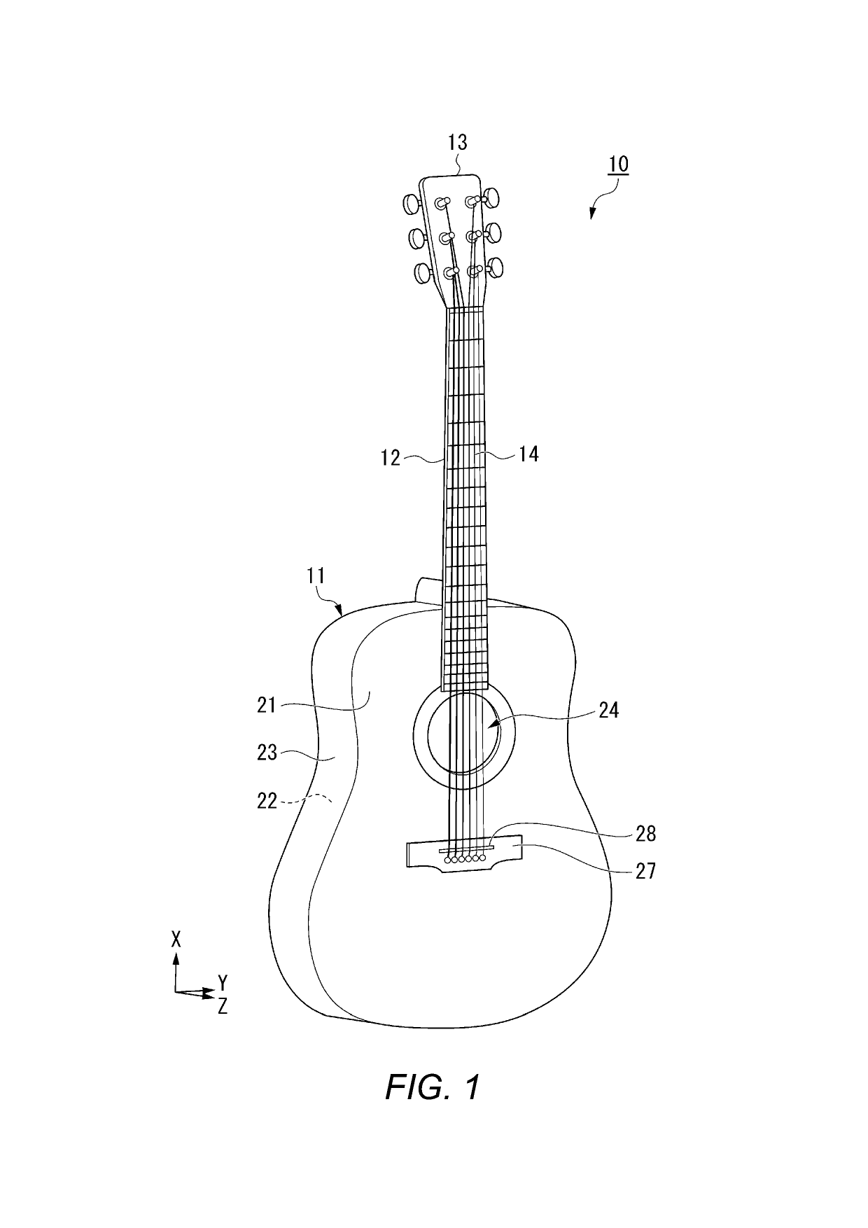

First, one example of a string instrument to which a plate material of this disclosure is applied will be described, with reference to FIG. 1. A string instrument 10 illustrated in FIG. 1 is an acoustic guitar and includes a body 11, a neck 12, a head 13, and strings 14.

The body 11 is formed in a box shape having a cavity therein. The body 11 includes a top plate 21, a back plate 22, and a side plate 23 forming the cavity. The top plate 21 and the back plate 22 are arranged spaced apart from each other in the plate thickness direction thereof. The side plate 23 extends from the peripheral edge of the back plate 22 to the peripheral edge of the top plate 21. A sound hole 24 penetrating in the plate thickness direction is formed in the top plate 21. The cavity of the body 11 is connected to the space outside of the body 11 via the sound hole 24. A tailpiece 27 fastening first ends of the strings 14 in the longitudinal direction is provided on the outer surface of the top plate 21.

The neck 12 extends in a direction away from the body 11. The head 13 is provided at the distal end of the neck 12 and winds the second end sides of the strings 14 in the longitudinal direction.

The strings 14 are stretched across the body 11 and the neck 12. Specifically, one end of each of the strings 14 is fastened to the tailpiece 27 of the body 11 and the second ends of the strings 14 are wound at the head 13. As a result, the strings 14 are stretched between the tailpiece 27 and the head 13.

A bridge 28 is provided between the outer surface of the top plate 21 and the strings 14 that are strung above the outer surface of the top plate 21. As a result, in the string instrument 10, the vibration of the strings 14 are transmitted to the top plate 21 via the bridge 28, thereby vibrating the top plate 21. Furthermore, the air inside the body 11 (void) vibrates in response to the vibration of the top plate 21, and the sound is radiated outside of the body 11.

The plate material of this disclosure is a plate material that generates sound through vibration, and can be applied to the top plate 21 of the string instrument 10 described above. The plate material of this disclosure can be applied to the back plate 22 or the side plate 23 of the string instrument 10, for example.

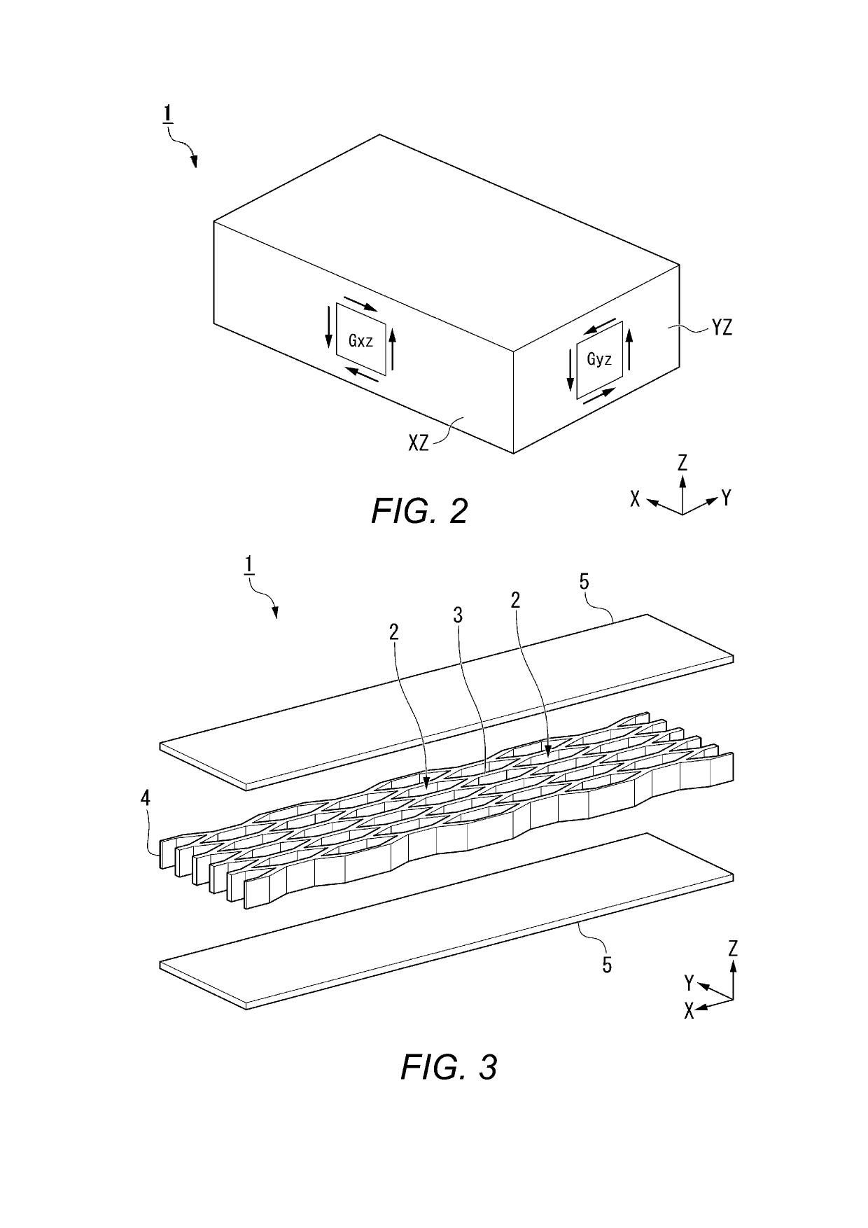

In the plate material 1 of this disclosure, as shown in FIG. 2, a first shear modulus Gyz in a plane YZ (first plane) including a plate thickness direction (Z-axis direction) of the plate material 1 and a first direction (Y-axis direction) perpendicular to the plate thickness direction is lower than a second shear modulus Gxz in a plane XZ (second plane) including the plate thickness direction (Z-axis direction) and a second direction (X-axis direction) perpendicular to the plate thickness direction and to the first direction. That is, the plate material 1 of this disclosure has anisotropy with respect to the shear modulus.

If the "specific type of wood" targeted by the plate material of this disclosure is straight-grained spruce, it is preferable that the second shear modulus Gxz is about 10 to 20 times the first shear modulus Gyz.

In all of FIGS. 1 and 3-10, the plate thickness direction, the first direction, and the second direction in the plate material of this disclosure are respectively indicated as the Z-axis direction, the Y-axis direction, and the X-axis direction. The X-axis direction, Y-axis direction, and Z-axis direction in FIG. 1 indicate one example of the directions when the plate material of this disclosure is applied to the top plate 21 (or the back plate 22).

### First Embodiment

The first embodiment of this disclosure will be described below, with reference to FIGS. 3-5.

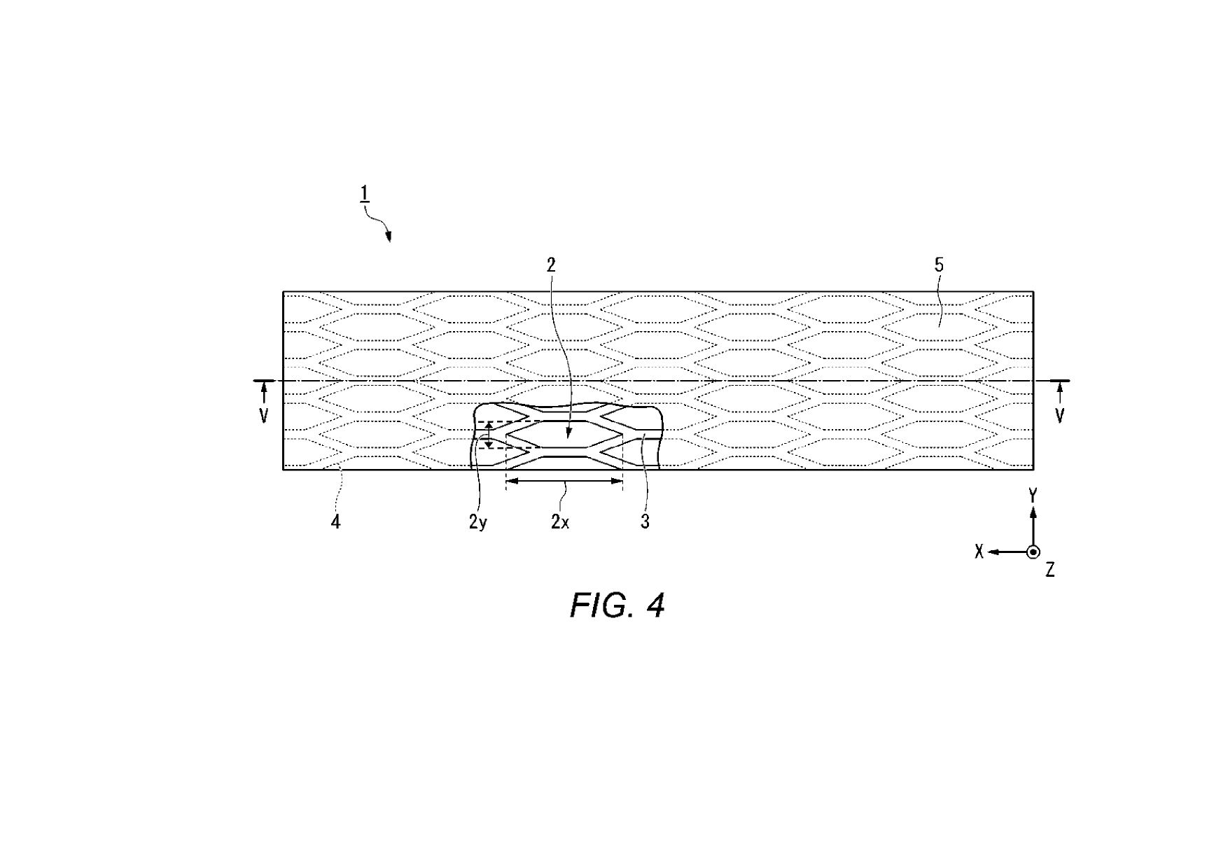

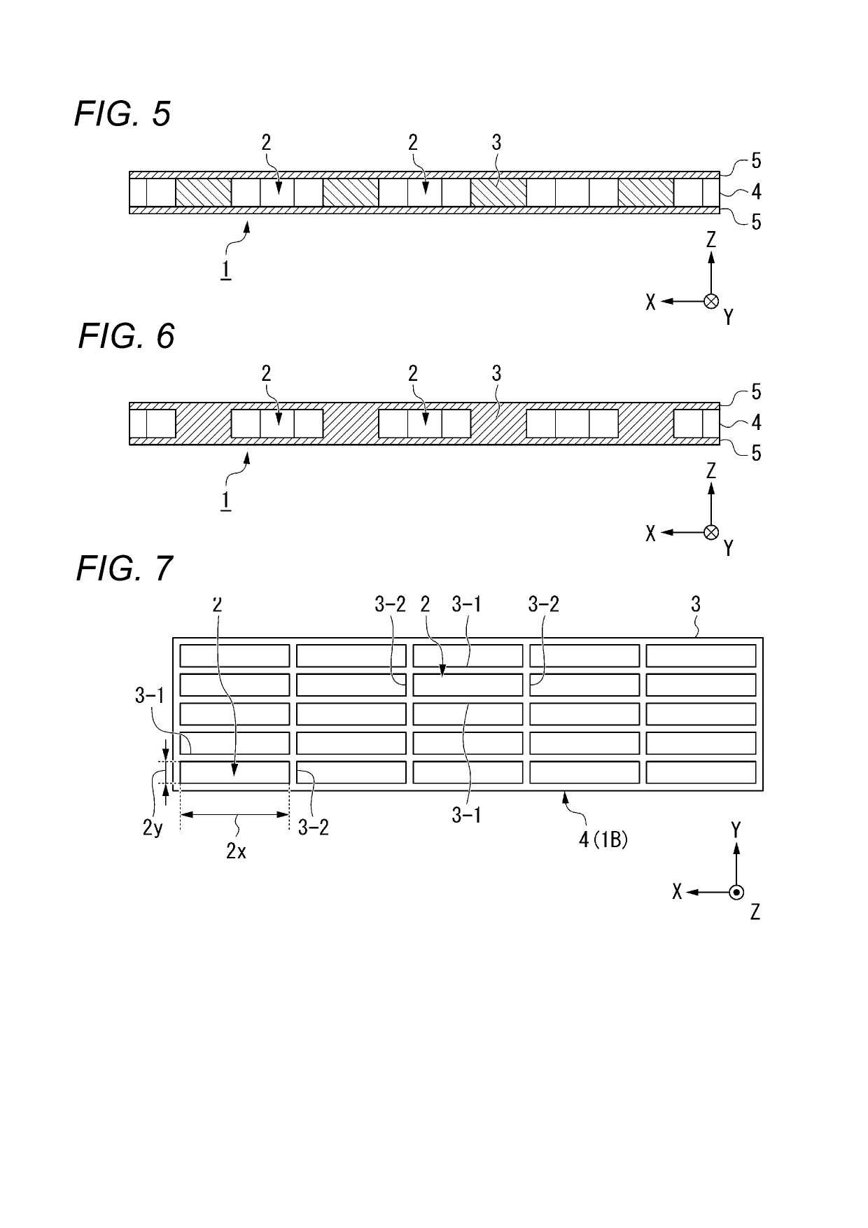

As shown in FIGS. 4 and 5, a plate material 1 of the first embodiment has a plurality of voids 2 therein. The plurality of voids 2 are arranged spaced apart from each other in a planar direction of the plate material 1 including the first direction and the second direction. In the present embodiment, the plurality of voids 2 are uniformly distributed in the planar direction. In the present embodiment, there is only one layer in the plate thickness direction that includes the plurality of voids 2 arranged in the planar direction of the plate material 1. It should be noted that a plurality of layers including the plurality of voids 2 arranged in the planar direction can be superposed on top of each other in the plate thickness direction, for example.

A second dimension 2x of the voids 2 in the second direction is larger than a first dimension 2y of the voids 2 in the first direction. The comparison of the first dimension 2y and the second dimension 2x is for the same void 2. That is, for the same void 2, the second dimension 2x is larger than the first dimension 2y.

All of the voids 2 in the plate material 1 have the same shape and size. The voids 2 in the first embodiment are formed in a symmetrical hexagonal shape as viewed from the plate thickness direction of the plate material 1. Specifically, the voids 2 have a shape in which a regular hexagon is stretched in the second direction. In FIG. 4, a pair of parallel sides of the voids 2 having a hexagonal shape in plan view are extended in the second direction. The pair of parallel sides of the voids 2 having a hexagonal shape in plan view can be extended in the first direction.

The shape and size of the voids 2 as viewed from the plate thickness direction do not change in the plate thickness direction. As a result, the three-dimensional shape of the voids 2 is hexagonal prism in which the second dimension 2x is greater than the first dimension 2y.

The plurality of voids 2, each having a hexagonal shape in plan view, are arranged so as to form a honeycomb structure. In addition, the plurality of voids 2 are arranged in the planar direction such that the thickness dimension of a partition wall 3 that partitions the voids 2 (adjacent voids) that are adjacent to each other in the planar direction are approximately uniform.

As shown in FIGS. 3 and 5, the plate material 1 of the first embodiment includes a first layer 4 and a second layer 5.

The first layer 4 is a layer whose thickness direction is the Z-axis direction, and includes the plurality of voids 2. The plurality of voids 2 are each open to both sides of the first layer 4 in the thickness direction of the first layer 4. That is, each of the voids 2 penetrates the first layer 4 in the thickness direction.

The second layer 5 is a layer whose thickness direction is the Z-axis direction, in the same manner as the first layer 4. The second layer 5 is superposed on the first layer 4 in the thickness direction. In the present embodiment, the second layer 5 is superposed on each side of the first layer 4 in the thickness direction. As a result, the openings on both sides of the voids 2 of the first layer 4 are closed by the second layer 5.

The strength of the second layer 5 is higher than the strength of the first layer 4. The "strength" of the first layer 4 and the second layer 5 can mean "the degree to which the first layer 4 and the second layer 5 can be deformed by external force without breaking."

In the present embodiment, the tensile modulus of the second layer 5 in the first direction (Y-axis direction) is lower than the tensile modulus of the second layer 5 in the second direction (X-axis direction). That is, the second layer 5 has anisotropy with respect to the tensile modulus.

In the present embodiment, the second layer 5 does not have voids. The second layer 5 can have voids, for example. However, in consideration of the fact that the strength of the second layer 5 is higher than the strength of the first layer 4, the size of the voids of the second layer 5 is preferably smaller than that of the voids 2 of the first layer 4. In addition, in the voids of the second layer 5, the second dimension is preferably greater than the first dimension, in the same manner as in the voids 2 of the first layer 4.

The substrate (material) constituting the plate material 1 can be any general-purpose resin, light metal, super engineering plastic, fiber-reinforced plastic (FRP), wood material other than the specific types of wood, or the like. The substrate constituting the first layer 4 and the substrate constituting the second layer 5 can be the same as or different from each other.

The plate material 1 of the present embodiment can be manufactured by, for example, preparing the first layer 4 and the second layer 5, and then superposing the second layer 5 on the first layer 4. The first layer 4 and the second layer 5 can each be produced using a 3D printer, for example.

In the string instrument 10 of FIG. 1 to which the plate material 1 of the present embodiment configured as described above is applied, the second direction (X-axis direction) of the plate material 1 substantially coincides with the longitudinal direction of the strings 14. Here, "substantially coincides with" means that the second direction of the plate material 1 can perfectly match the longitudinal direction of the strings 14, or be slightly inclined with respect to the longitudinal direction of the strings 14. In consideration of the anisotropy in the directions parallel/perpendicular to the strings 14, for example, the upper limit of the inclination angle of the second direction of the plate material 1 with respect to the longitudinal direction of the strings 14 is preferably less than 45 degrees. On the other hand, the lower limit of the inclination angle can be, for example, 0 degrees, but in a case in which the plate material 1 is designed to have a notch, the lower limit is preferably 10 degrees or more in order to ensure strength.

As described above, according to the first embodiment, since the plate material 1 has the plurality of voids 2 inside arranged spaced apart from each other in the planar direction including the first direction and the second direction, it becomes possible to obtain the plate material 1 in which the first shear modulus Gyz is lower than the second shear modulus Gxz. Specifically, because the second dimension 2x of each of the voids 2 is greater than the first dimension 2y, it is possible to obtain the plate material 1 in which the first shear modulus Gyz is lower than the second shear modulus Gxz.

In addition, because the plate material 1 has anisotropy described above with respect to the shear modulus, it is possible to generate a suitably soft sound in the same manner as the specific types of wood, even with the plate material 1 (for example, the plate material 1 that is inexpensive or easily available) made of a material other than the specific types of wood. A suitably soft sound is, for example, a sound in which the magnitude of high-order vibrations (high-frequency sounds) is smaller than that of metal (e.g., aluminum) and larger than that of foam material.

In addition, in the plate material 1 of the first embodiment, the plurality of voids 2 have the same shape and size. Therefore, compared to a case in which the plurality of voids 2 have different shapes and sizes, the number of parameters for adjusting the properties of the plate material 1 (for example, the ratio between the first dimension 2y and the second dimension 2x of each of the voids 2) can be kept small. Accordingly, it is possible to easily design the plate material 1 in which the first shear modulus Gyz is lower than the second shear modulus Gxz.

In addition, the plate material 1 of the first embodiment has the first layer 4 including the plurality of voids 2, and the second layer 5 that is superposed on the first layer 4 in the plate thickness direction and that has a higher strength than the first layer 4. As a result, even if the first layer 4 has a low strength due to the presence of the voids 2, the strength of the plate material 1 can be reinforced by the second layer 5.

Additionally, in the plate material 1 of the first embodiment, the tensile modulus of the second layer 5 in the first direction is lower than the tensile modulus of the second layer 5 in the second direction. As a result, the properties of lower-order vibrations (low-frequency sounds) that occur in the plate material 1 can be brought closer to those of the specific types of wood (for example, spruce).

In addition, in the plate material 1 of the first embodiment, the second layer 5 is superposed on each side of the first layer 4 in the plate thickness direction. As a result, it is possible to effectively suppress warping of the plate material 1.

In addition, in the plate material 1 of the first embodiment, the voids 2 penetrate the first layer 4 in the thickness direction. As a result, when the plate material 1 is formed only by the first layer 4, it is not possible to obtain a sufficient amount of sound pressure generated as the plate material vibrates. In contrast, in the plate material 1 of the first embodiment, by superposing the second layers 5 on both sides of the first layer 4, the openings on both sides of the voids 2 are closed by the second layers 5. It is thereby possible to obtain a sufficient amount of sound pressure generated as the plate material 1 vibrates.

Furthermore, in the string instrument 10 (musical instrument) having the plate material 1 of the first embodiment, it is possible to provide the string instrument 10 that can generate a suitably soft sound, even when the string instrument 10 is formed by the plate material 1 (for example, the plate material 1 that is inexpensive or easily available) made of a material other than the specific types of wood.

In addition, in the string instrument 10 having the plate material 1 of the first embodiment, the second direction of the plate material 1 substantially coincides with the longitudinal direction (that is, the direction in which the strings are strung) of the strings 14. As a result, it is possible to effectively suppress or prevent the plate material 1 from bending due to the tensile force of the strings 14.

In the plate material 1 of the first embodiment, the first layer 4 and the second layer 5 can be integrally formed, as shown in FIG. 6, for example. In this case, the first layer 4 and the second layer 5 can be, for example, produced at the same time using a 3D printer.

In the first embodiment, the plurality of voids 2 included in the first layer 4 can be open only on one side of the first layer 4 in the thickness direction, for example. In this case, it is possible to obtain a sufficient amount of sound pressure generated as the plate material 1 vibrates, simply by superposing the second layer 5 on only one side of the first layer 4 where the voids 2 are open, to close the openings of the voids 2.

In addition, the plurality of voids 2 included in the first layer 4 do not need to be open on both sides of the first layer 4 in the thickness direction, for example. In this case, the second layer 5 can be superposed on each side of the first layer 4 in the thickness direction, or superposed only on one side of the first layer 4. In addition, the plate material 1 does not need to include the second layer 5, that is, the plate material 1 can be formed only by the first layer 4.

### Second Embodiment

Next, the second embodiment of this disclosure will be described with reference to FIG. 7. In the following description, the configurations that are the same as those already explained have been assigned the same reference numerals and redundant descriptions have been omitted.

A plate material of the second embodiment is different from the plate material 1 of the first embodiment only in the shape of the voids 2 in the first layer 4. FIG. 7 shows only the first layer 4 of a plate material 1B of the second embodiment in plan view.

As shown in FIG. 7, the shape of the voids 2 in plan view as viewed from the plate thickness direction (Z-axis direction) is a rectangular shape in which the second dimension 2x is greater than the first dimension 2y. In addition, the shape and size of the voids 2 as viewed from the plate thickness direction do not change in the plate thickness direction. As a result, the three-dimensional shape of the voids 2 is a rectangular parallelepiped in which the second dimension 2x is greater than the first dimension 2y. The plurality of voids 2 have the same shape and size.

The plurality of voids 2 that are rectangular in plan view are arranged spaced apart from each other in the first and second directions so as to constitute a planar grid structure. In addition, the plurality of voids 2 are arranged such that the thickness dimension of the partition wall 3 that partitions the voids 2 (adjacent voids) that are adjacent to each other in the planar direction is approximately uniform.

Specifically, the partition wall 3 includes first partition walls 3-1 in which the first direction is the wall thickness direction and second partition walls 3-2 in which the second direction is the wall thickness direction. The first partition walls 3-1 and the second partition walls 3-2 have the same thickness dimension. The plate material 1B of the second embodiment exhibits the same effects as those of the first embodiment.

### Third Embodiment

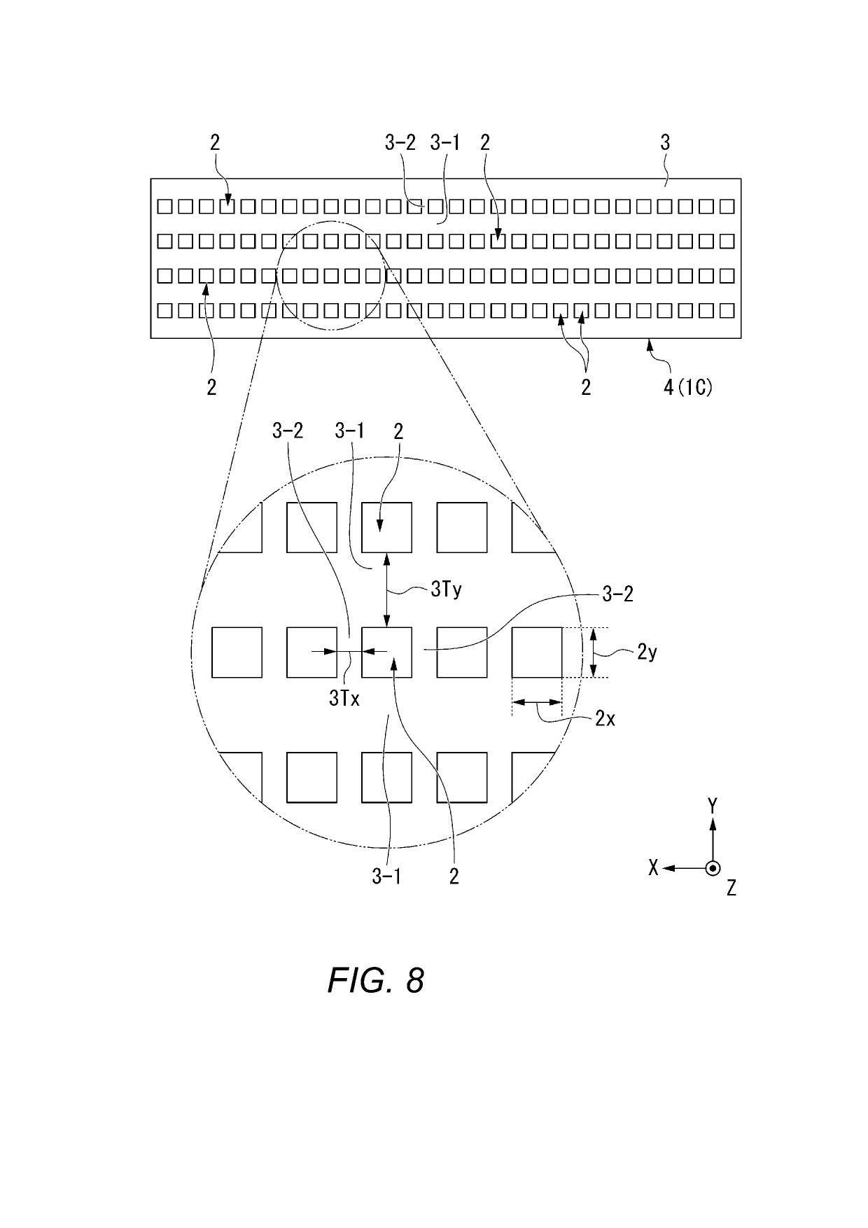

Next, the third embodiment of this disclosure will be described with reference to FIG. 8. In the following description, the configurations that are the same as those already explained have been assigned the same reference numerals and redundant descriptions have been omitted.

A plate material of the third embodiment is different from the first and second embodiments in the shape of the voids 2 of the first layer 4 and the form of the partition wall 3. FIG. 8 shows only the first layer 4 of a plate material 1C of the third embodiment in plan view.

As shown in FIG. 8, the shape of the voids 2 in plan view as viewed from the plate thickness direction (Z-axis direction) is a square shape in which the second dimension 2x and the first dimension 2y are equal. In addition, the shape and size of the voids 2 as viewed from the plate thickness direction do not change in the plate thickness direction. Therefore, the three-dimensional shape of the voids 2 is a rectangular parallelepiped or a cube. The plurality of voids 2 have the same shape and size.

The plurality of voids 2 that are each square in plan view are arranged spaced apart from each other in the first and second directions so as to constitute a planar grid structure, in the same manner as in the second embodiment. In addition, the plurality of voids 2 are arranged such that the intervals between the voids 2 in the first direction are greater than the intervals between the voids 2 in the second direction.

Specifically, the partition wall 3 that partitions the voids 2 (adjacent voids) that are adjacent to each other in the planar direction including the first and second directions include the first partition walls 3-1 in which the first direction is the wall thickness direction and the second partition walls 3-2 in which the second direction is the wall thickness direction. A thickness dimension 3Ty of the first partition wall 3-1 is larger than a thickness dimension 3Tx of the second partition wall 3-2. The thickness dimension 3Ty of the first partition wall 3-1 corresponds to the intervals between the voids 2 in the first direction. The thickness dimension 3Tx of the second partition wall 3-2 corresponds to the intervals between the voids 2 in the second direction.

The plate material 1C of the third embodiment exhibits the same effects as those of the first embodiment.

In addition, in the plate material 1C of the third embodiment, the thickness dimension 3Ty of the first partition wall 3-1 is greater than the thickness dimension 3Tx of the second partition wall 3-2. Therefore, the shear modulus of the second partition wall 3-2 is lower than the shear modulus of the first partition wall 3-1, and the rigidity of the first partition wall 3-1 is higher than the rigidity of the second partition wall 3-2. Furthermore, the shear modulus of the second partition wall 3-2 corresponds to the first shear modulus Gyz (refer to FIG. 2) and the shear modulus of the first partition wall 3-1 corresponds to the second shear modulus Gxz (refer to FIG. 2). Accordingly, even if the first dimension 2y and the second dimension 2x of the same void 2 are equal, it is possible to form the plate material 1C in which the first shear modulus Gyz is lower than the second shear modulus Gxz.

The configuration of the third embodiment, that is, the configuration in which the thickness dimension 3Ty of the first partition wall 3-1 is larger than the thickness dimension 3Tx of the second partition wall 3-2, and the configuration in which the shear modulus of the second partition wall 3-2 is lower than the shear modulus of the first partition wall 3-1, can be applied to the plate material 1 in which the shape of the voids 2 in plan view is a hexagonal shape, as in the first embodiment.

It is sufficient if the first partition wall 3-1 is the partition wall 3 in which the wall thickness direction is mainly oriented in the first direction, and can include the partition wall 3 in which the inclination angle of the partition wall 3 in the wall thickness direction relative to the first direction is 45 degrees or less, for example. On the other hand, it is sufficient if the second partition wall 3-2 is the partition wall 3 in which the wall thickness direction is mainly oriented in the second direction, and can include the partition wall 3 in which the inclination angle of the partition wall 3 in the wall thickness direction relative to the second direction is 45 degrees or less, for example.

In addition, for example, the first partition wall 3-1 in which the wall thickness direction is mainly oriented in the first direction can be the portion of the partition wall 3 orthogonally projected in the first direction, and the second partition wall 3-2 in which the wall thickness direction is oriented in the second direction can be the portion of the partition wall 3 orthogonally projected in the second direction.

### Fourth Embodiment

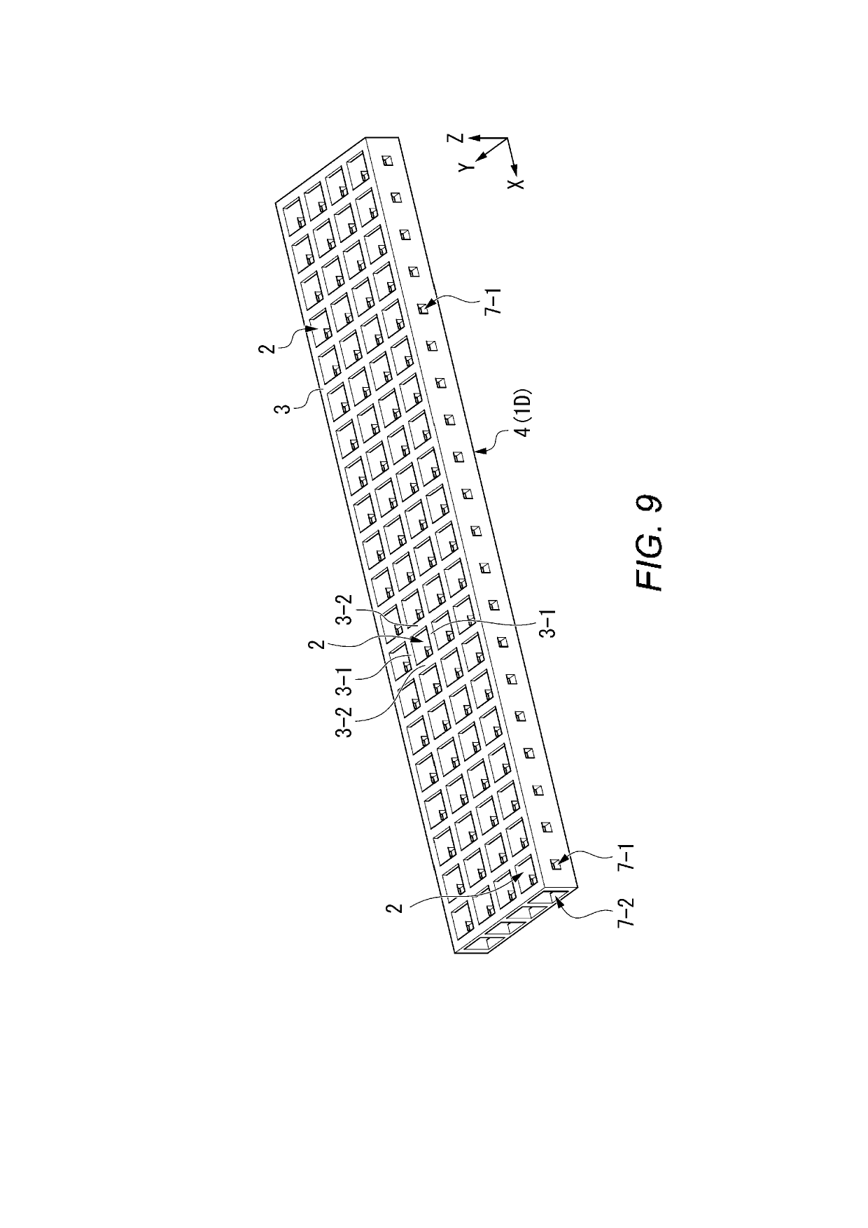

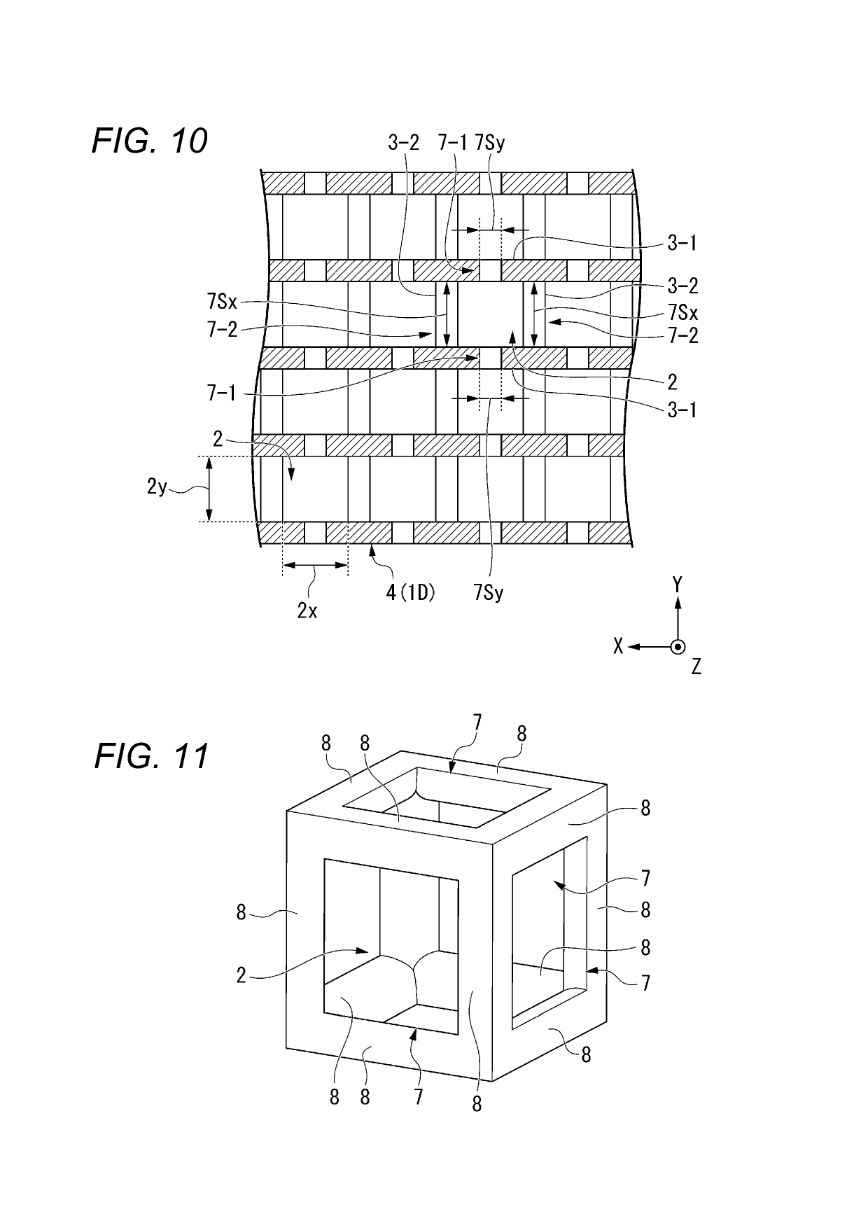

The fourth embodiment of this disclosure will be described with reference to FIGS. 9 and 10. In the following description, the configurations that are the same as those already explained have been assigned the same reference numerals and redundant descriptions have been omitted.

A plate material of the fourth embodiment is different from the third embodiment in the form of the partition wall 3. FIGS. 9 and 10 show only the first layer 4 of a plate material 1D of the fourth embodiment.

As shown in FIG. 10, the shape of the voids 2 in plan view as viewed from the plate thickness direction (Z-axis direction) is a square shape in which the second dimension 2x and the first dimension 2y are equal, in the same manner as in the third embodiment. In addition, as shown in FIGS. 9 and 10, the shape and size of the voids 2 as viewed from the plate thickness direction do not change in the plate thickness direction. Therefore, the three-dimensional shape of the voids 2 is a rectangular parallelepiped or a cube. The plurality of voids 2 have the same shape and size.

The plurality of voids 2 that are square in plan view are arranged spaced apart from each other in the first and second directions so as to constitute a planar grid structure, in the same manner as in the third embodiment. However, the plurality of voids 2 are arranged such that the intervals between the voids 2 in the first direction are equal to the intervals between the voids 2 in the second direction. Specifically, the partition wall 3 that partitions the voids 2 (adjacent voids) that are adjacent to each other in the planar direction including the first and second directions include the first partition walls 3-1 in which the first direction is the wall thickness direction and the second partition walls 3-2 in which the second direction is the wall thickness direction. The thickness dimension of the first partition wall 3-1 is equal to the thickness dimension of the second partition wall 3-2.

In the first layer 4 of the fourth embodiment, a plurality of through-holes 7 (7-1, 7-2), which connect the voids 2 that are adjacent to each other, are formed in the partition walls 3. In the entire first layer 4 (plate material 1D), the sum of first areas of the through-holes 7 as projected in the first direction is smaller than the sum of second areas of the through-holes 7 as projected in the second direction.

Specifically, in the plate material 1D illustrated in FIGS. 9 and 10, the plurality of through-holes 7 include first through-holes 7-1 and second through-holes 7-2. The first through-holes 7-1 penetrate the first partition walls 3-1 in the first direction. For this reason, an area 7Sy of the first through-hole 7-1 as viewed from the direction of penetration is entirely included in the above-mentioned first area. On the other hand, the second through-holes 7-2 penetrate the second partition walls 3-2 in the second direction. For this reason, an area 7Sx of the second through-hole 7-2 as viewed from the direction of penetration is entirely included in the above-mentioned second area.

The area 7Sy (first area) of the first through-holes 7-1 as viewed from the first direction is smaller than the area 7Sx (second area) of the second through-holes 7-2 as viewed from the second direction. The areas 7Sy (first areas) of the plurality of first through-holes 7-1 are equal to each other. The areas 7Sx (second areas) of the plurality of second through-holes 7-2 are equal to each other. Therefore, in the entire first layer 4 (plate material 1D), the sum of the areas 7Sy (first areas) of the plurality of first through-holes 7-1 is smaller than the sum of the areas 7Sx (second area) of the plurality of second through-holes 7-2.

The plate material 1D of the fourth embodiment exhibits the same effects as those of the first embodiment.

In addition, in the plate material 1D of the fourth embodiment, the plurality of through-holes 7 that connect the voids 2 that are adjacent to each other formed in the partition wall 3. Then, the sum of the first areas of the through-holes 7 as projected in the first direction is smaller than the sum of the second areas of the through-holes 7 as projected in the second direction. As a result, even if the first dimension 2y and the second dimension 2x of the same void 2 are equal, and even if the thickness dimension of the first partition wall 3-1 and the thickness dimension of the second partition wall 3-2 are equal, it is possible to form the plate material 1D in which the first shear modulus Gyz is lower than the second shear modulus Gxz.

For example, in the first layer 4 (plate material 1D) illustrated in FIG. 10, the area 7Sy (first area) of the first through-hole 7-1 formed in the first partition wall 3-1 is smaller than the area 7Sx (second area) of the second through-hole 7-2 formed in the second partition wall 3-2. Therefore, the shear modulus of the first partition wall 3-1 is higher than the shear modulus of the second partition wall 3-2, and the rigidity of the first partition wall 3-1 is higher than the rigidity of the second partition wall 3-2. Furthermore, the shear modulus of the second partition wall 3-2 corresponds to the first shear modulus Gyz (refer to FIG. 2) and the shear modulus of the first partition wall 3-1 corresponds to the second shear modulus Gxz (refer to FIG. 2). Accordingly, even if the first dimension 2y and the second dimension 2x of the same void 2 are equal, and even if the thickness dimension of the first partition wall 3-1 and the thickness dimension of the second partition wall 3-2 are equal, it is possible to form the plate material 1D in which the first shear modulus Gyz is lower than the second shear modulus Gxz.

The configuration of the fourth embodiment, that is, the configuration in which a plurality of the through-holes 7 that connect the voids 2 that are adjacent to each other are formed in the partition wall 3, and the sum of the first areas of the through-holes 7 as projected in the first direction is smaller than the sum of the second areas of the through-holes 7 as projected in the second direction, can be applied to the plate material 1 in which the shape of the voids 2 in plan view is a hexagonal shape, as in the first embodiment.

In the fourth embodiment, for example, the plan-view shape of the first through-holes 7-1 as viewed from the first direction can be different from the plan-view shape of the second through-holes 7-2 as viewed from the second direction, whereby the shear modulus of the second partition wall 3-2 is lower than the shear modulus of the first partition wall 3-1. In this case, by making the plan-view shape of the first through-holes 7-1 different from the plan-view shape of the second through-holes 7-2, even if the first dimension 2y and the second dimension 2x of the same void 2 are equal, and even if the area of the first through-hole 7-1 as viewed from the first direction and the area of the second through-hole 7-2 as viewed from the second direction are equal, it is possible to form the plate material 1D in which the shear modulus of the first partition wall 3-1 is lower than the shear modulus of the second partition wall 3-2.

The plan-view shapes of the first and second through-holes 7-1, 7-2 being different from each other means that, for example, even if the areas of the figures of the first and second through-holes 7-1, 7-2 in plan view (plan-view figures) are the same, the shapes themselves of the plan-view figures of the first and second through-holes 7-1, 7-2 are different from each other. For example, the plan-view figure of the first through-holes 7-1 can be a rectangle while the plan-view figure of the second through-holes 7-2 can be a circle. In this case, the shear modulus of the second partition wall 3-2 can be made lower than the shear modulus of the first partition wall 3-1.

In addition, the plan-view shapes of the first and second through-holes 7-1, 7-2 being different from each other can mean that, for example, the plan-view shapes of the first and second through-holes 7-1, 7-2 are the same plan-view figure that is not point-symmetric, and the plan-view shapes of the first and second through-holes 7-1, 7-2 are different from each other due to the rotational positions of the plan-view figures being different between the first through-holes 7-1 and the second through-holes 7-2. Examples of plan-view figures of the first and second through-holes 7-1, 7-2 that are not point-symmetric figures include polygons such as triangles and rectangles, ellipses, and the like. For example, the plan-view figures of the first and second through-holes 7-1, 7-2 can both be squares, and the plan-view figures of the first and second through-holes 7-1, 7-2 can be rotated 45 degrees relative to each other.

When the plan-view figures of the first and second through-holes 7-1, 7-2 are squares having the same area, for example, each side of the first through-hole 7-1 that is square in plan view formed in the first partition wall 3-1 can be inclined (for example, inclined by 45 degrees) relative to the plate thickness direction of the plate material (Z-axis direction) and the second direction (X-axis direction), and each side of the second through-hole 7-2 that is square in plan view formed in the second partition wall 3-2 can be aligned with the plate thickness direction of the plate material (Z-axis direction) and the second direction (X-axis direction). As a result, the shear modulus of the second partition wall 3-2 becomes lower than the shear modulus of the first partition wall 3-1.

This disclosure was described in detail above, but this disclosure is not limited to the embodiments described above, and can be modified within the scope of the spirit of this disclosure.

In the plate material 1 (1B, 1C, 1D) of this disclosure, the voids 2 can be filled with a filler, such as a foam material. In this case, the density of the filler can be lower than the density of the first layer 4, for example. In addition, the filler is preferably lighter in weight than the second layer 5, for example.

In the plate material 1 (1B, 1C, 1D) of this disclosure, the voids 2 can have any shape. For example, the plan-view shape of the voids 2 as viewed from the plate thickness direction, the first direction, or the second direction, is not limited to a hexagonal shape or a rectangular/square shape, and can be another polygon, a circle, an ellipse, or the like. In addition, the three-dimensional shape of the voids 2 can be any shape, such as a cylinder, an ellipsoid, a hexahedron, or an octahedron.

The "honeycomb structure" in this disclosure is not limited to including only a structure in which the plurality of voids 2, each of which has a hexagonal shape in plan view, are arranged as in the first embodiment, and can include a structure in which each void 2is formed in any polygonal shape in plan view, and the plurality of voids 2 are arranged such that the sides of adjacent voids 2 are parallel to each other, and that the intervals between the adjacent voids 2 are small.

In the plate material 1 of this disclosure, the voids 2 can have a plurality of types of shapes and sizes. That is, the single plate material 1 (1B, 1C, 1D) can include a plurality of types of the voids 2 having different shapes and sizes. In this case, the properties of the plate material can be adjusted more precisely.

In this disclosure, the specific structure by which the plurality of voids 2 are arranged inside the plate material 1 (1B, 1C, 1D) is not limited to the honeycomb structure or the planar grid structure as described in the embodiments above, and can be a lattice structure, expanded metal, mesh sheet, woven structure, or the like.

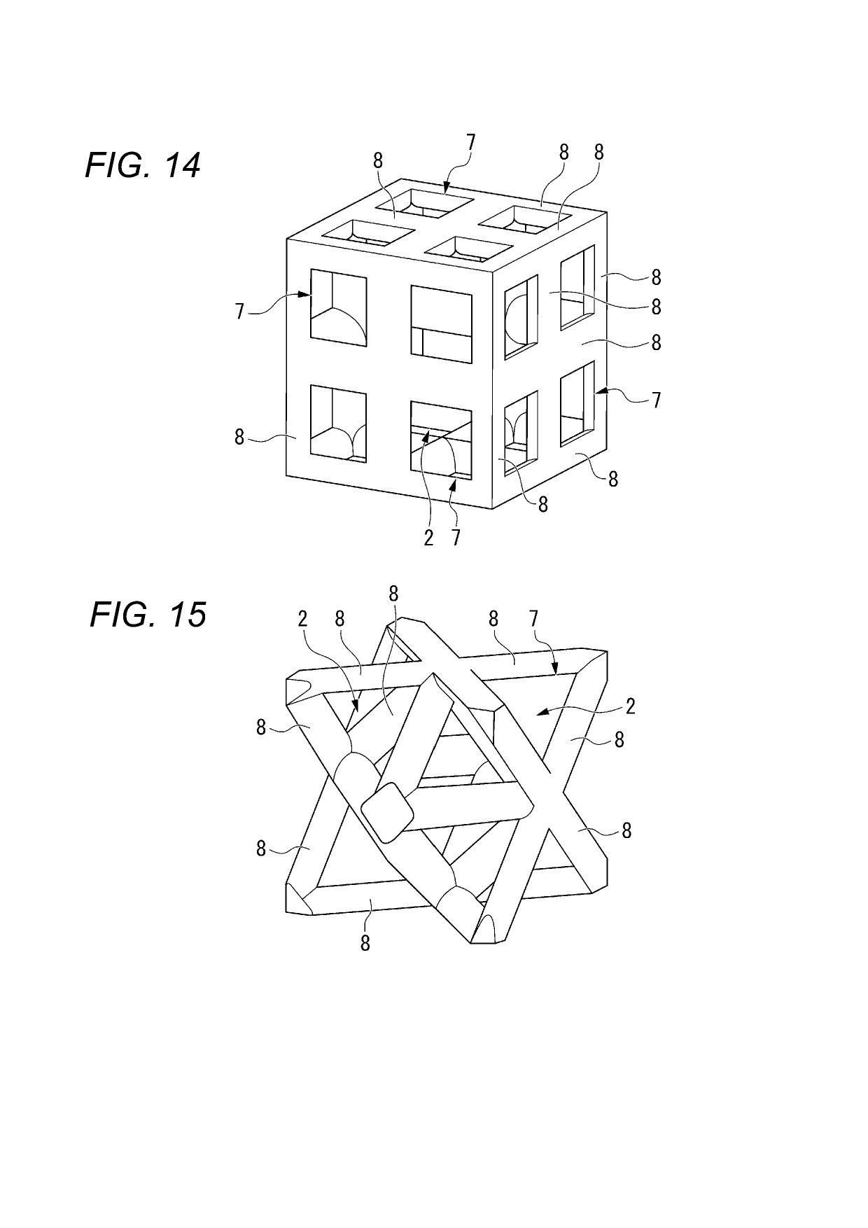

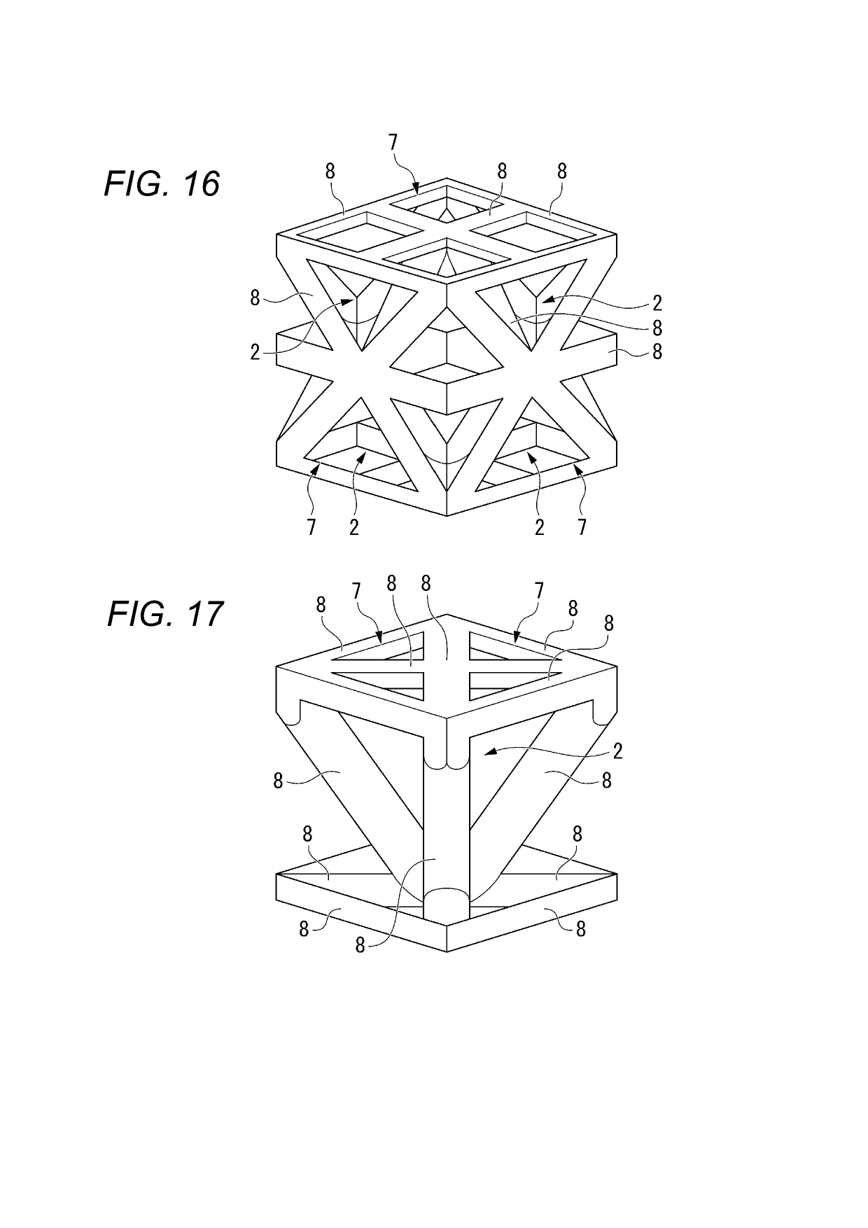

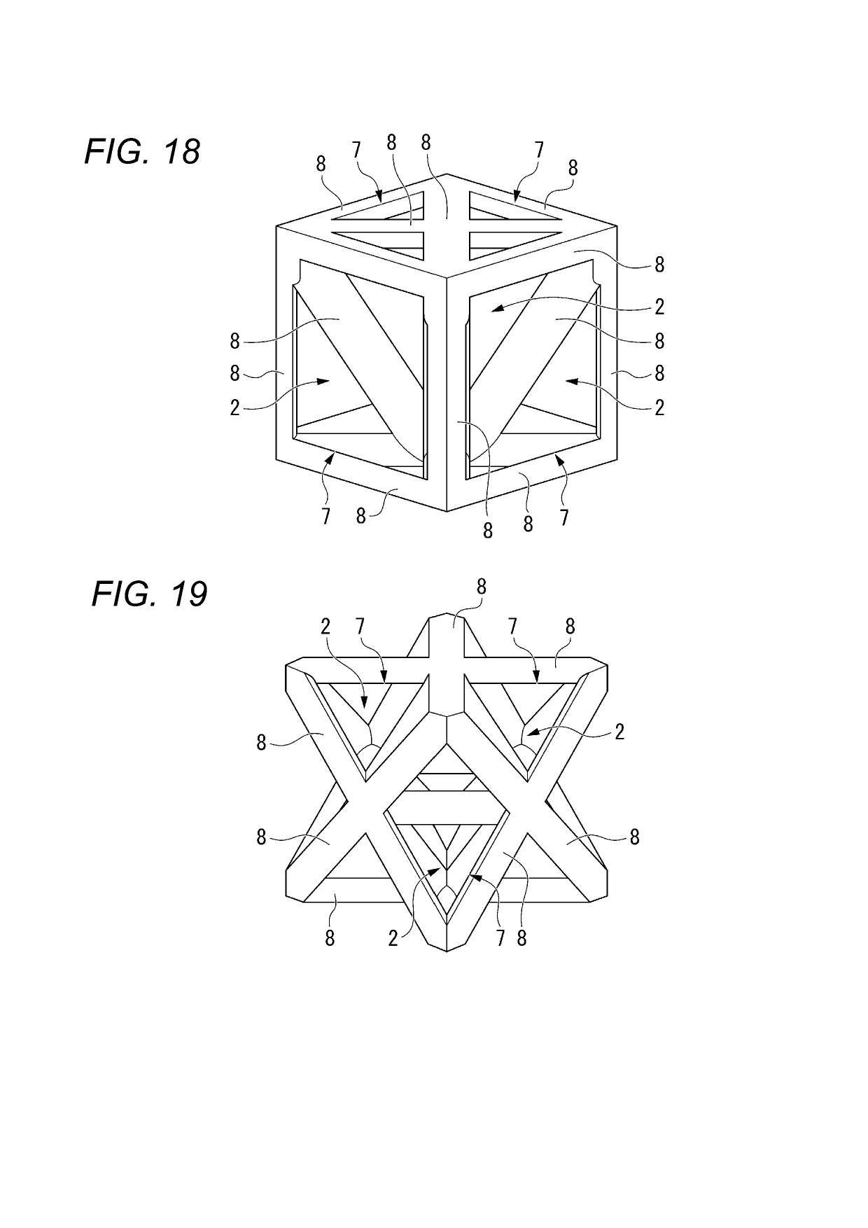

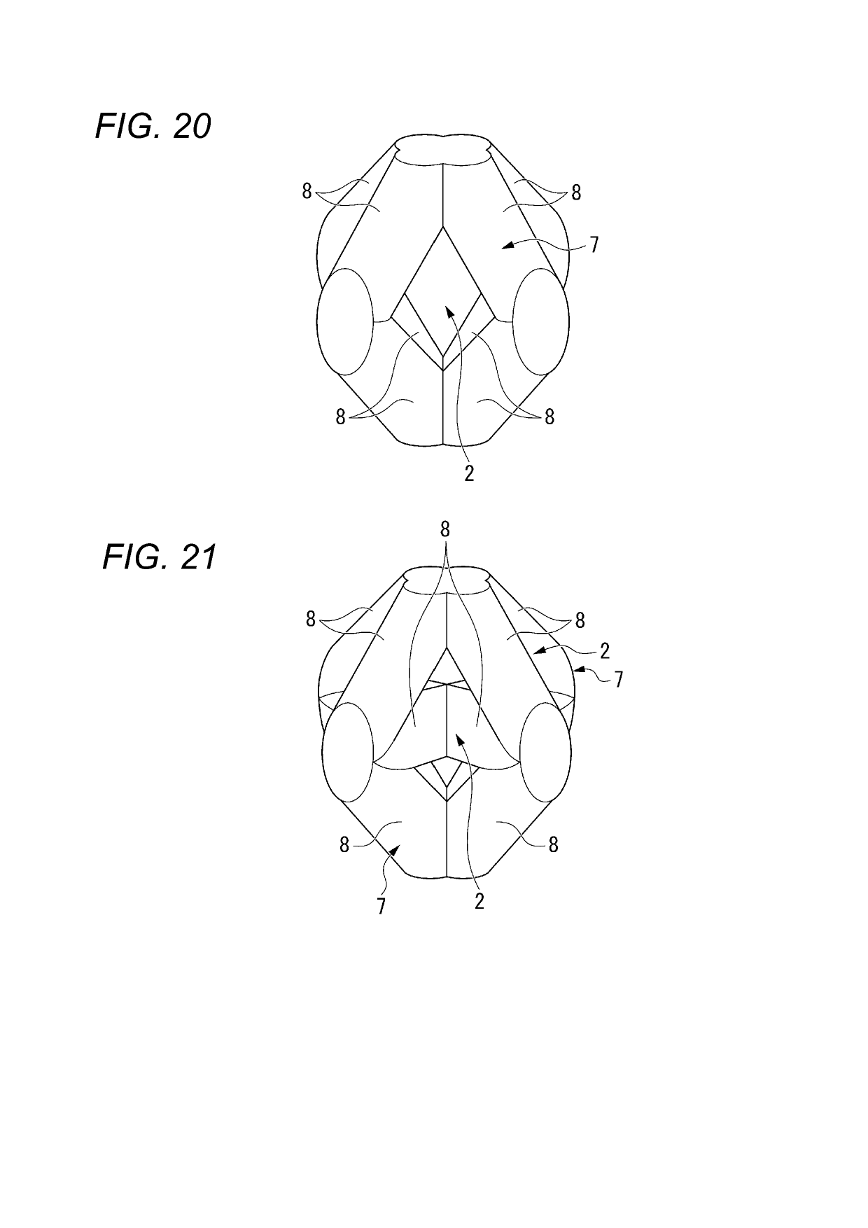

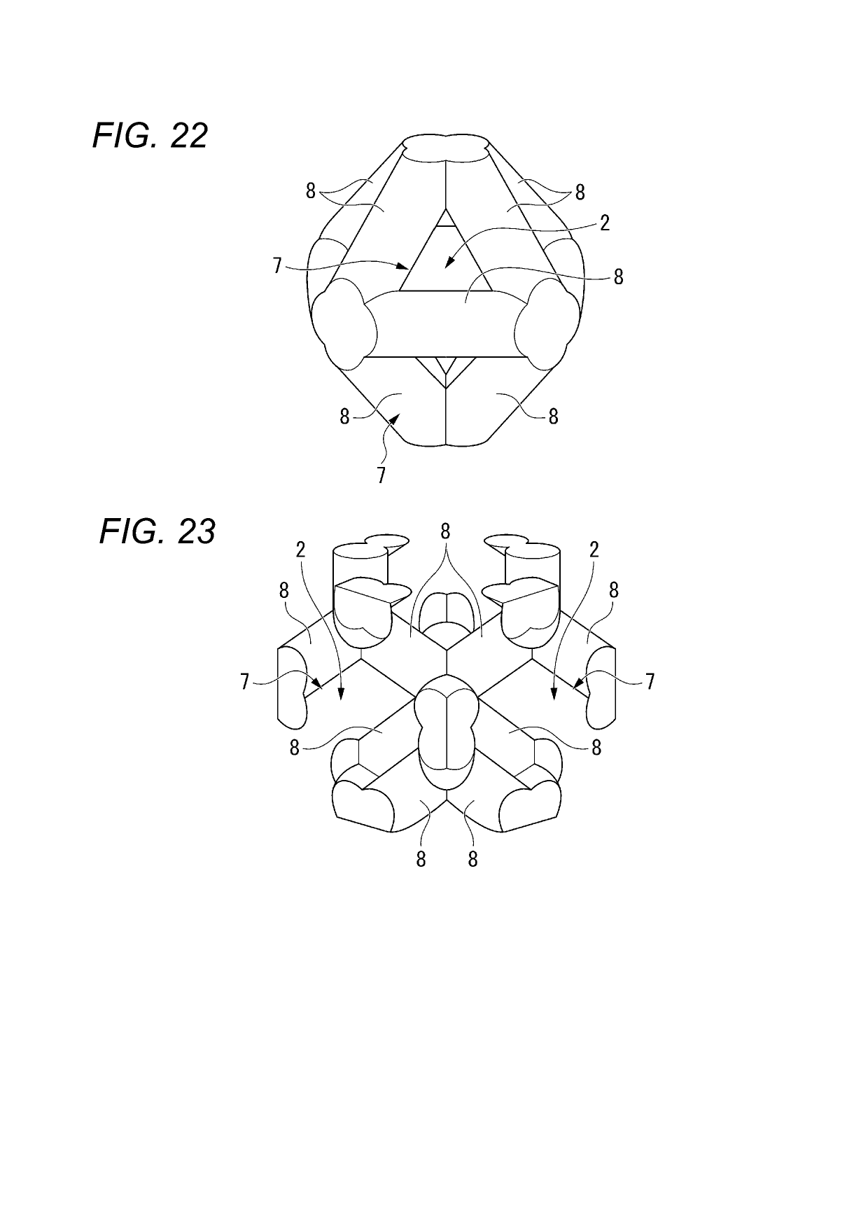

FIGS. 11 to 23 each show an example of one unit of a lattice structure. The plate material 1 (1B, 1C, 1D) of this disclosure that adopts a lattice structure can be configured by arranging a plurality of the single units of a lattice structure shown in each of FIGS. 11 to 23 in at least the first and second directions.

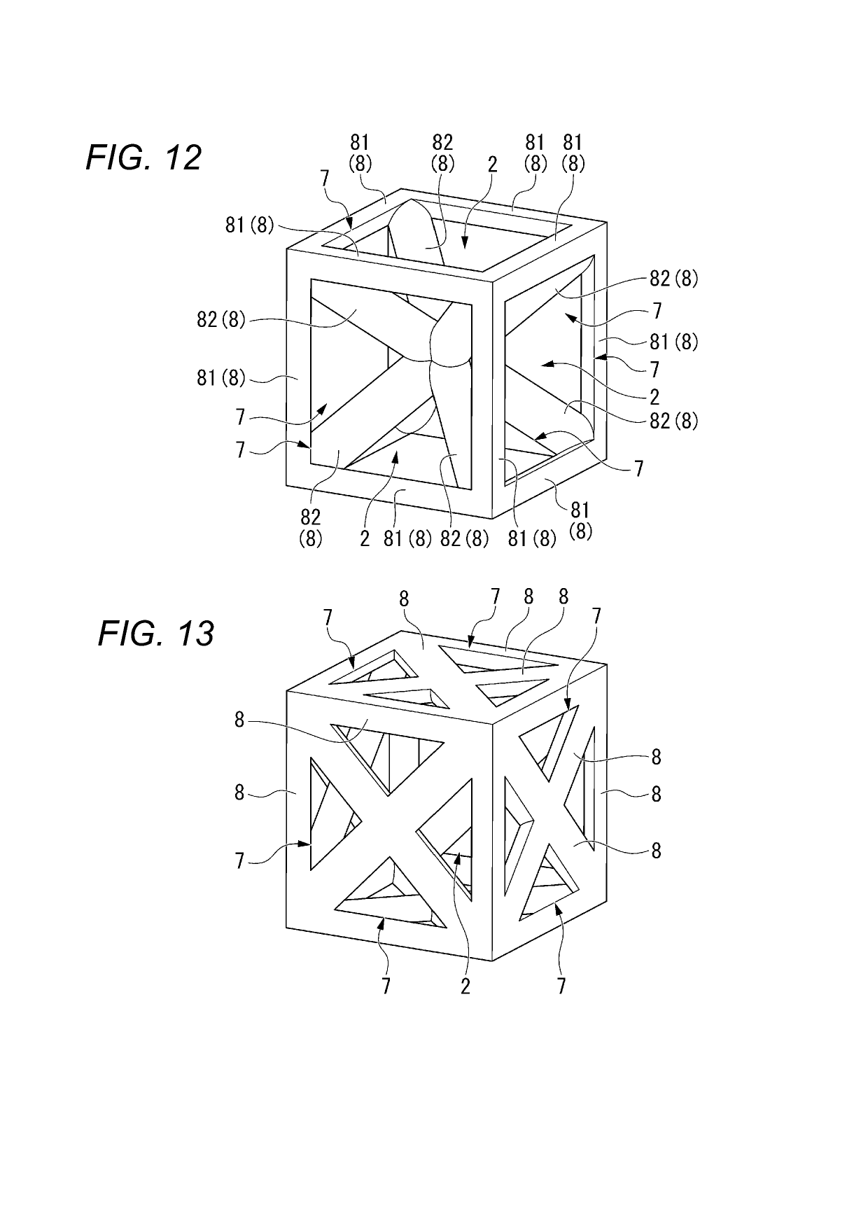

The single unit of a lattice structure shown in each of FIGS. 11 to 23 is formed by appropriately connecting a plurality of beams 8. For example, the lattice structure of FIG. 12 has, among the plurality of beams 8, outer beams 81that constitute the outer frame of the lattice structure, and inner beams 82 that extend inside the outer frame.

In the lattice structures shown in FIGS. 11 to 23, the three-dimensional shape of the smallest unit formed by several of the beams 8 corresponds to the void 2 of this disclosure. For example, in the lattice structure of FIG. 12, four of the outer beams 81 forming a square and four of the inner beams 82 that extend from each of the corners formed by the four outer beams 81 to the center of the cube form a quadrangular pyramid. The space inside this quadrangular pyramid corresponds to the void 2 of this disclosure. In the lattice structure of FIG. 12, there are six quadrangular pyramids constituting the voids 2.

In addition, in the lattice structures shown in FIGS. 11 to 23, the planar shape of the smallest unit formed by several of the beams 8 corresponds to the partition wall of this disclosure. For example, in the lattice structure of FIG. 12, each of the square portion formed by four of the outer beams 81 and the triangle portion formed by one of the outer beams 81 and two of the inner beams 82 extending from both ends of the outer beam 81 corresponds to the partition wall of this disclosure.

In addition, in the lattice structure shown in FIGS. 11 to 23, the portion surrounded by several of the beams 8 constituting the planar shape of the smallest unit corresponds to the through-hole 7 of this disclosure. For example, in the lattice structure of FIG. 12, the inside portion of the square formed by four of the outer beams 81 and the inside portion of the triangle formed by one of the outer beams 81 and two of the inner beams 82 extending from both ends of the outer beam 81, each correspond to the through-hole 7 of this disclosure.

In this disclosure, properties of the plate material 1 (1B, 1C, 1D) such as shear modulus, flexural modulus, and tensile modulus, can be uniform throughout the plate material, but can be different for each region of the plate material, for example.

In the plate material 1 (1B, 1C, 1D) of this disclosure, the plurality of voids 2 can be unevenly distributed in the planar direction, for example. For example, in a portion of the plate material1 (1B, 1C, 1D) where it is necessary to ensure strength, the number of the voids 2 per unit area can be reduced, or the voids 2 can be made smaller, compared to the other portions of the plate material 1 (1B, 1C, 1D). In this case, it is possible to vary the properties of the plate material 1 (1B, 1C, 1D) for each region of the plate material, as described above.

The plate material 1 (1B, 1C, 1D) of this disclosure can be applied not only to the string instrument 10 (acoustic guitar) illustrated in FIG. 1 but also to various instruments that use plate materials that generate sound by vibrating, such as other string instruments such as electric guitars and violin, pianos, percussion instruments, and the like. That is, the plate material of this disclosure can be a plate material for musical instruments.

In addition, the plate material 1 (1B, 1C, 1D) of this disclosure is not limited to being applied to musical instruments and can be applied to audio equipment such as speakers. In this case, the plate material of this disclosure can be applied to the diaphragm or the housing of the speaker, for example.

### Effects of this disclosure

According to this disclosure, it is possible to provide a plate material that can generate a suitably soft sound even when the plate material is made of a material other than specific types of wood, as well as a musical instrument and a string instrument that comprise such a plate material.

What is claimed is:

1. A plate material comprising:
a first layer including a plurality of voids, the plurality of voids being arranged spaced apart from each other in a planar direction including a first direction and a second direction, the first direction being perpendicular to a plate thickness direction of the plate material, the second direction being perpendicular to the plate thickness direction and to the first direction,
a first shear modulus in a first plane including the plate thickness direction and the first direction being lower than a second shear modulus in a second plane including the plate thickness direction and the second direction.

2. The plate material according to claim 1, wherein
a second dimension of each of the plurality of voids in the second direction is larger than a first dimension of each of the plurality of voids in the first direction.

3. The plate material according to claim 1, wherein
the first layer further includes a partition wall that partitions adjacent voids among the plurality of voids, the adjacent voids are adjacent to each other in the planar direction,
the partition wall includes
a first partition wall in which a wall thickness direction of the first partition wall is the first direction and
a second partition wall in which a wall thickness direction of the second partition wall is the second direction, and
a shear modulus of the second partition wall is lower than a shear modulus of the first partition wall.

4. The plate material according to claim 1, wherein
the first layer further includes a partition wall that partitions adjacent voids among the plurality of voids, the adjacent voids are adjacent to each other in the planar direction,
the partition wall includes
a first partition wall in which a wall thickness direction of the first partition wall is the first direction and
a second partition wall in which a wall thickness direction of the second partition wall is the second direction, and
a thickness dimension of the first partition wall in the first direction is larger than a second thickness dimension of the second partition wall in the second direction.

5. The plate material according to claim 1, wherein
the first layer includes a partition wall that partitions adjacent voids among the plurality of voids, the adjacent voids are adjacent to each other in the planar direction,
the partition wall has a plurality of through-holes each of which connects the adjacent voids, and
a sum of first areas of the plurality of through-holes as projected in the first direction is smaller than a sum of second areas of the plurality of through-holes as projected in the second direction.

6. The plate material according to claim 1, wherein
the first layer includes a partition wall that partitions adjacent voids among the plurality of voids, the adjacent voids are adjacent to each other in the planar direction,
the partition wall has a plurality of through-holes each of which connects the adjacent voids,
the partition wall has
a first partition wall in which a wall thickness direction of the first partition wall is the first direction and
a second partition wall in which a wall thickness direction of the second partition wall is the second direction,
the plurality of through-holes include first through-holes formed on the first partition wall and second through-holes formed on the second partition wall, and
a plan-view shape of each of the first through-holes as viewed from the first direction is different from a plan-view shape of each of the second through-holes as viewed from the second direction, such that a shear modulus of the second partition wall is lower than a shear modulus of the first partition wall.

7. The plate material according to claim 1, further comprising
a second layer that is superposed on the first layer in the plate thickness direction and that has a higher strength than the first layer.

8. The plate material according to claim 7, wherein
a tensile modulus of the second layer in the first direction is lower than a tensile modulus of the second layer in the second direction.

9. The plate material according to claim 7, wherein
the second layer is superposed on each side of the first layer in the plate thickness direction.

10. A musical instrument comprising:
the plate material according to claim 1.

11. A string instrument comprising:
the plate material according to claim 1; and
strings,
the second direction of the plate material substantially coinciding with a longitudinal direction of the strings.
